(19) United States
(12) Patent Application Publication
(10) Pub. No.: US 2022/0222556 A1
(43) Pub. Date: Jul. 14, 2022

(54) ROAD TRAFFIC JAM EARLY WARNING METHOD AND SYSTEM

(71) Applicant: SHANDONG JIAOTONG UNIVERSITY, Shandong (CN)

(72) Inventors: Mengmeng ZHANG, Shandong (CN); Ji HUANG, Shandong (CN); Yue YU, Shandong (CN)

(73) Assignee: SHANDONG JIAOTONG UNIVERSITY, Shandong (CN)

(21) Appl. No.: 17/609,408

(22) PCT Filed: Jan. 7, 2021
(86) PCT No.: PCT/CN2021/070686

§ 371 Date: Nov. 8, 2021

(30) Foreign Application Priority Data
Apr. 30, 2020 (CN) 202010364099.9

(51) Int. Cl. G06N 7/02; G08G 1/01; G06N 20/10; G06Q 50/30

(52) U.S. Cl. CPC G06N 7/02; G08G 1/0108; G06Q 50/30; G06N 20/10; G08G 1/0133

(57) ABSTRACT

A road traffic jam early warning method includes: performing characteristic classification according to acquired multi-source traffic data, and constructing a corresponding characteristic membership function, to obtain a first fuzzy weight; applying an expert evaluation method to the multi-source data to construct an artificial membership function, and calculating a second fuzzy weight; performing fuzzy weighted average on the characteristic membership function according to a fused fuzzy weight obtained by fusing the first fuzzy weight and the second fuzzy weight, and performing defuzzification on obtained weighted average membership functions having different characteristic quantities, to obtain fused multi-source traffic data; constructing a road traffic congestion model, and calculating an optimal road traffic congestion index; and acquiring current multi-source traffic data, predicting a current congestion index, and providing, by comparing the current congestion index with the optimal road traffic congestion index, a warning about whether a current road is congested.

### TECHNICAL FIELD

The present disclosure relates to the technical field of intelligent transportation, and in particular to a road traffic jam early warning method and system.

### BACKGROUND

The description in this section merely provides background information related to the present disclosure and does not necessarily constitute the prior art.

In recent years, with an increase in vehicles traveling on the road, a traveling environment on the road becomes more complex, a probability of traffic congestion is greatly increased, traveling safety of the vehicles on the road is subjected to great threats, a traveling speed is greatly reduced, and a time of arriving at destinations may also be delayed. When the road is in use, traveling states of the vehicles may be influenced by various factors such as vehicle states, weather environments, behavior of pedestrians and drivers, and the like. However, the inventors found that conventional road traffic warning platforms have some defects. The conventional warning platforms for road congestion mostly uses single sensing devices as data collection sources, which only consider the influence of road conditions or vehicles themselves, and data collected from a data collection terminal is not complete enough. Evaluation indexes for a degree of road congestion are too simple without considering the important role of human perception and group experience in urban road congestion and neglects improvement of traffic control rules through management experience of traffic managers. During the construction of urban road traffic warning platforms, the complexity of the traffic system and the important role of people in the traffic system are not considered, and congestion warning for drivers has not formed a complete congestion warning network.

### SUMMARY

In order to resolve the above problems, the present disclosure provides a road traffic jam early warning method and system. Multi-source traffic parameters of human, a vehicle, a road, and an environment are collected, multi-source data fusion is implemented through fuzzy logic inference and a minimum variance weighted average method, and road congestion indexes are calculated by using a kernel extreme learning machine algorithm. At a warning stage of road congestion, congestion determination is performed by using the congestion indexes, and a man-machine hybrid augmented intelligence multi-source data fusion system that gives full play to collective wisdom of road participants is constructed.

To achieve the foregoing objective, the present disclosure uses the following technical solutions:

According to a first aspect, the present disclosure provides a road traffic jam early warning method, including:

performing characteristic classification according to acquired multi-source traffic data, constructing a corresponding characteristic membership function, and applying a minimum weighted average algorithm to the characteristic membership function to obtain a first fuzzy weight;

applying an expert evaluation method to the multi-source data to construct an artificial membership function, and calculating a second fuzzy weight;

performing fuzzy weighted average on the characteristic membership function according to a fused fuzzy weight obtained by fusing the first fuzzy weight and the second fuzzy weight, and performing defuzzification on obtained weighted average membership functions having different characteristic quantities, to obtain fused multi-source traffic data;

applying a kernel extreme learning machine group algorithm to the fused multi-source traffic data to construct a road traffic congestion model, and calculating an optimal road traffic congestion index; and

acquiring current multi-source traffic data, predicting a current congestion index according to the road traffic congestion model, and providing, by comparing the current congestion index with the optimal road traffic congestion index, a warning about whether a current road is congested.

According to a second aspect, the present disclosure provides a warning system for road traffic congestion, including:

a first fuzzy weight calculation module, configured to perform characteristic classification according to acquired multi-source traffic data, construct a corresponding characteristic membership function, and apply a minimum weighted average algorithm to the characteristic membership function to obtain a first fuzzy weight;

a second fuzzy weight calculation module, configured to apply an expert evaluation method to the multi-source data to construct an artificial membership function, and calculate a second fuzzy weight;

a fusion module, configured to perform fuzzy weighted average on the characteristic membership function according to a fused fuzzy weight obtained by fusing the first fuzzy weight and the second fuzzy weight, and perform defuzzification on obtained weighted average membership functions having different characteristic quantities, to obtain fused multi-source traffic data;

a model construction module, configured to apply a kernel extreme learning machine group algorithm to the fused multi-source traffic data to construct a road traffic congestion model, and calculate an optimal road traffic congestion index; and

a congestion warning module, configured to acquire current multi-source traffic data, predict a current congestion index according to the road traffic congestion model, and provide, by comparing the current congestion index with the optimal road traffic congestion index, a warning about whether a current road is congested.

According to a third aspect, the present disclosure provides an electronic device, including a memory, a processor, and a computer instruction stored in the memory and executable on the processor, when the computer instruction is executed by the processor, the method in the first aspect being completed.

According to a fourth aspect, the present disclosure provides a computer-readable storage medium configured to store a computer instruction, when the computer instruction is executed by a processor, the method in the first aspect being completed.

Compared with the prior art, the present disclosure has the following beneficial effects:

In the present disclosure, characteristic analysis is performed on different road congestion indexes according to four factors of road traffic, and management experience of traffic managers is combined with machine intelligence through a traffic management platform, so as to construct an intelligent congestion warning platform based on a man-machine hybrid augmented control rule base. The role of human are introduced in a calculation circuit of a congestion warning system, and a capability of dealing with fuzzy and uncertain problems of human is tightly coupled with a capability of precise calculation of the machine, thereby forming an advanced cognitive response mechanism with man-machine coordination and two-way communication and control of information, so that perceptual and cognitive capabilities of human are combined with the powerful operation and storage capacity of the computer, so as to form a man-machine hybrid augmented intelligence form of “1+1>2”.

In the present disclosure, human and machine intelligence are organically combined, road traffic participants acquire road traffic data and road characteristic information through their own senses, perform mutual verification with real-time data provided by each sensor, and perform independent determination according to the experience provided by validation experts, which give full play to the capability of rapid and precise computing of the machine and the capability of dealing with fuzzy problems of human, so that the reliability and flexibility of the system will be greatly improved.

### BRIEF DESCRIPTION OF THE DRAWINGS

The accompanying drawings constituting a part of the present disclosure are used to provide further understanding of the present disclosure. Exemplary embodiments of the present disclosure and descriptions thereof are used to explain the present disclosure, and do not constitute an improper limitation to the present disclosure.

FIG. 1 is a flowchart of a man-machine hybrid augmented intelligence multi-source data fusion subsystem according to Embodiment 1 of the present disclosure.

FIG. 2 is a diagram of a sensing device data collection submodule according to Embodiment 1 of the present disclosure.

FIG. 3 is a diagram of a traffic participant data collection submodule according to Embodiment 1 of the present disclosure.

FIG. 4 is a diagram of a man-machine hybrid augmented multi-source data collection subsystem according to Embodiment 1 of the present disclosure.

FIG. 5 is a flowchart of a warning subsystem for man-machine hybrid augmented intelligence congestion according to Embodiment 1 of the present disclosure.

FIG. 6 is a general drawing of a warning platform for urban road traffic based on man-machine hybrid augmented intelligence according to Embodiment 1 of the present disclosure.

### DETAILED DESCRIPTION

The present disclosure is further described below with reference to the accompanying drawings and embodiments.

It should be noted that the following detailed descriptions are all exemplary and are intended to provide a further description of the present disclosure. Unless otherwise specified, all technical and scientific terms used herein have the same meaning as commonly understood by a person of ordinary skill in the technical field to which the present disclosure belongs.

It should be noted that terms used herein are only for describing specific implementations and are not intended to limit exemplary implementations according to the present disclosure. As used herein, the singular form is also intended to include the plural form unless the context clearly dictates otherwise. In addition, it should further be understood that, terms “include” and/or “comprise” used in this specification indicate that there are features, steps, operations, devices, components, and/or combinations thereof.

### Embodiment 1

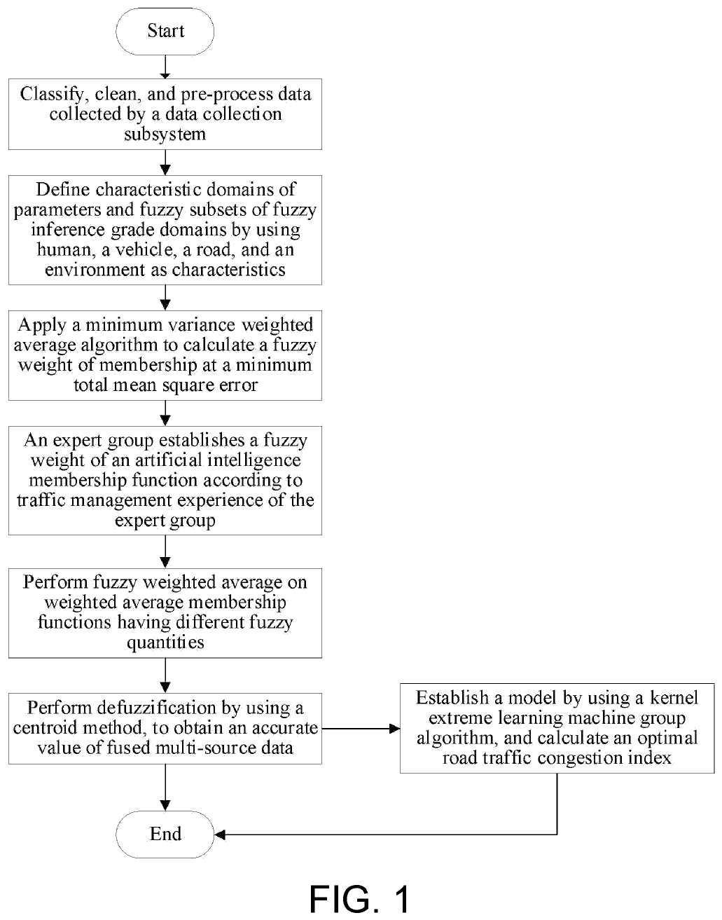

As shown in FIG. 1, an embodiment provides a road traffic jam early warning method, including:

S1: performing characteristic classification according to acquired multi-source traffic data, constructing a corresponding characteristic membership function, and applying a minimum weighted average algorithm to the characteristic membership function to obtain a first fuzzy weight;

S2: applying an expert evaluation method to the multi-source data to construct an artificial membership function, and calculating a second fuzzy weight;

S3: performing fuzzy weighted average on the characteristic membership function according to a fused fuzzy weight obtained by fusing the first fuzzy weight and the second fuzzy weight, and performing defuzzification on obtained weighted average membership functions having different characteristic quantities, to obtain fused multi-source traffic data;

S4: applying a kernel extreme learning machine group algorithm to the fused multi-source traffic data to construct a road traffic congestion model, and calculating an optimal road traffic congestion index; and

S5: acquiring current multi-source traffic data, predicting a current congestion index according to the road traffic congestion model, and providing, by comparing the current congestion index with the optimal road traffic congestion index, a warning about whether a current road is congested.

In this embodiment, human, vehicles, roads, and environments are used as influence factors of road traffic congestion. In step S1, a road characteristic, a human characteristic, an environment characteristic, and a vehicle characteristic are obtained after the characteristic classification is performed according to the acquired multi-source traffic data.

The road characteristic includes a traffic flow, a number of lanes, and a road grade.

The human characteristic includes a behavior characteristic of a driver and a behavior characteristic of a pedestrian, that is, road familiarity and driving skills of the driver, mental status, driving habits, reaction times, traffic violation information records of pedestrians and drivers, and times for pedestrians to pass at intersections.

The environment characteristic includes information such as road weather and a traffic accident, and understandably, may further include information such as large-scale activities along the road, and so on.

The vehicle characteristic includes a position, a speed, a distance headway, and a vehicle condition of a vehicle.

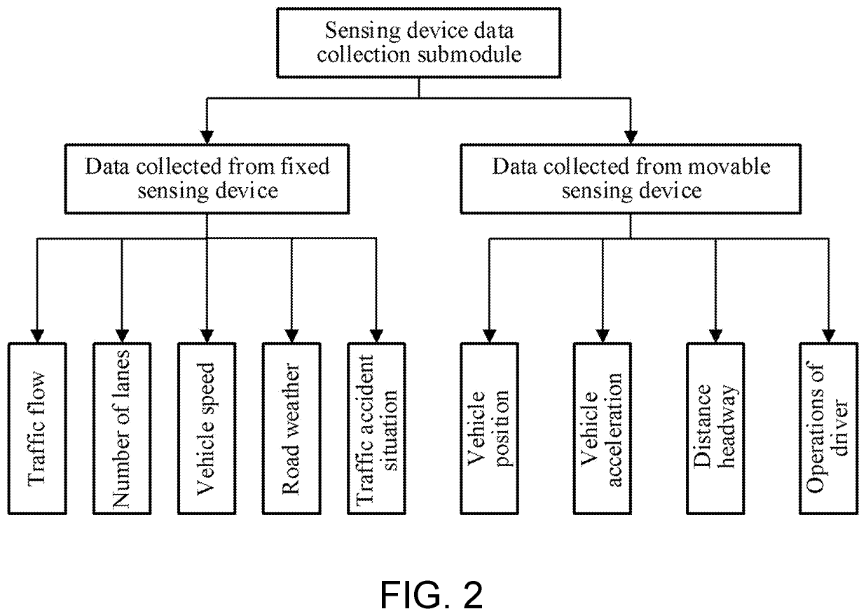

In this embodiment, as shown in FIG. 2, the process of collecting multi-source data is performed by various sensing devices and traffic participants. When vehicles are traveling on an urban road, a fixed sensing device laid on a road network collects road traffic data such as traffic flow, a number of lanes, a speed, road weather, and traffic accident situations. The fixed sensing device includes traffic sensing devices through infrared, geomagnetism, radar, coils, videos, and the like.

A movable sensing device mounted on the vehicle collects vehicle traffic data such as positions of the vehicles, vehicle acceleration, distances headway, and driver operation behaviors on road segments and behavior characteristic data of drivers. The movable sensing device includes a traffic sensing device such as an on-board navigation device, a license plate recognition device, and the like.

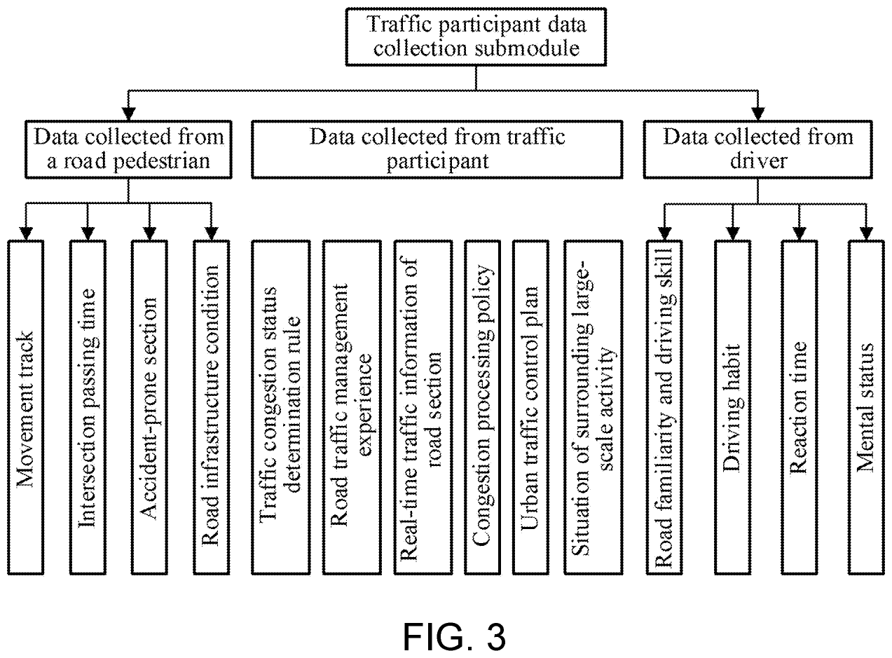

As shown in FIG. 3, the data collected from the traffic participants mainly includes information such as human perception, management experience, and policy activities. Firstly, basic road information such as a movement track, a time period of crossing an intersection, accident-prone sections, road infrastructure status of the pedestrians is provided by using the pedestrians on the urban road. Secondly, perceptual information of the driver such as road familiarity and driving skills of the driver, mental status, driving habits, reaction time, and the like is provided by means of a driver of a traveling vehicle. Thirdly, control policy experience information such as traffic congestion status determination rules, road traffic management experience, real-time traffic information of road sections, congestion processing policies, urban traffic control schemes, situations of surrounding large-scale activities, and the like is provided by a traffic manager.

In this embodiment, a man-machine hybrid platform for collecting urban road traffic information may be established by using the sensing devices mounted on the urban roads and the vehicles and traffic participants, which gives full play to the advantages of man-machine hybrid augmented intelligence.

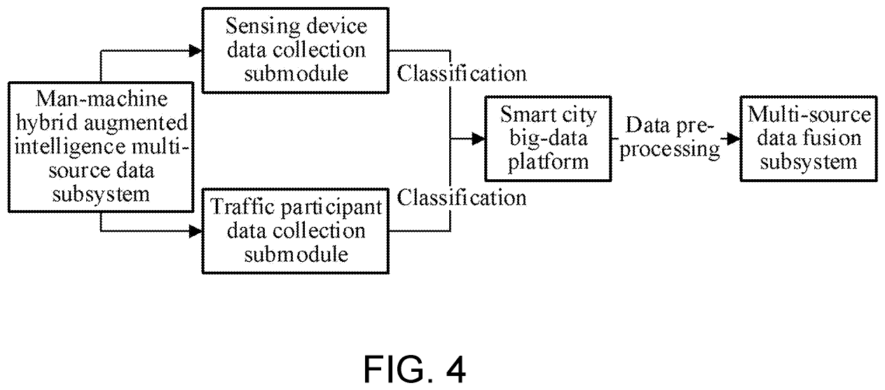

In this embodiment, as shown in FIG. 4, after multi-source traffic data is acquired and classified, various characteristic data is pre-processed, and multi-source data fusion may be performed on the pre-processed data, specifically including the following.

For multi-source heterogeneous data, adopted data processing methods are also different because categories of collected data are different, and grade standards are set, by using the experience of traffic managers or advices of experts, for road characteristic information such as weather and perception data of human such as mental status that cannot be directly quantized.

Text image information that is not easy to process is converted into numbers, and the numbers are merged with digitized data such as the speed, the distance headway, and the like for processing. Data pre-processing is performed by using methods of missing data elimination, approximation repair and completion, erroneous data correction, major data normalization processing, and the like.

Secondary cleaning is performed on the pre-processed multi-source data, obviously unreasonable data in problematic data may be eliminated, and experienced traffic managers and data processing experts are invited to analyze the data, thereby giving full play to the advantage of man-machine hybrid augmented intelligence.

In step S1, after the characteristic classification is finished, the corresponding characteristic membership function is constructed, including the following steps.

(1) Establish four different characteristic domains A_{JI}, B_{JI}, C_{JI}, D_{JI} according to a human characteristic, a vehicle characteristic, a road characteristic, and an environment characteristic.

(2) According to characteristic data included in each characteristic domain, set data of a traffic flow, a number of lanes, and a road grade to A₁₁, A₁₂, . . . , A_{1I}, A₂₁, A₂₂, . . . , A_{2I}, and A₃₁, A₃₂, . . . , A_{3I}, set data of road familiarity and driving skills of the driver, mental status, driving habits, reaction times, traffic violation information records of pedestrians and drivers, and times for pedestrians to pass at intersections to B₁₁, B₁₂, . . . , B_{1I}, B₂₁, B₂₂, . . . , B_{2I}, B₃₁, B₃₂, . . . , B_{3I}, B₄₁, B₄₂, . . . , B_{4I}, B₅₁, B₅₂, . . . , B_{5I}, and B₆₁, B₆₂, . . . , B_{6I}, set data of a position, a speed, a distance headway, and a vehicle condition of a vehicle to C₁₁, C₁₂, . . . , C_{1I}, C₂₁, C₂₂, . . . , C_{2I}, C₃₁, C₃₂, . . . , C_{3I}, and C₄₁, C₄₂, . . . , C_{4I}, and set data of information such as road weather, large-scale activities along the road, and a real-time traffic accident to D₁₁, D₁₂, . . . , D_{1I}, D₂₁, D₂₂, . . . , D_{2I}, and D₃₁, D₃₂, . . . , D_{3I}.

(3) Use each characteristic domain as an input variable, divide quantitative data into different grades by using group experience of traffic participants and traffic managers and machine intelligence, set different area ranges according to different grade standards to perform qualitative analysis, and establish a fuzzy inference rule table Aᵢⱼ. Bᵢⱼ, Cᵢⱼ, Dᵢⱼ.

(4) Establish fuzzy subsets Ãᵢ (i=1, . . . , I), \tilde{B}ᵢ (=1, . . . , I), \tilde{C}ᵢ (i=1, . . . , I), and \tilde{D}ᵢ (i=1, . . . , I) corresponding to fuzzy inference grade domains by using the fuzzy inference rule table.

(5) Obtain characteristic membership functions corresponding to fuzzy subsets of human, vehicles, roads, and environments as μ_{Ãi}, i=1, . . . , I, μ_{\tilde{B}i}, i=1, . . . , I, μ_{\tilde{C}i}, =1, . . . , I, and μ_{\tilde{D}i}, i=1, . . . , I by means of fuzzy mapping.

The applying a minimum variance weighted average algorithm of minimizing signal variance to the characteristic membership functions to obtain a first fuzzy weight ωᵢ corresponding to a minimum total mean square error includes the following.

(1) At a moment a, signals detected by the four different characteristic domains based on human, vehicles, roads, and environments are set to x₁ (a), x₂ (a), x₃ (a), and x₄ (a).

Let xᵢ(a)=dᵢ(a)+bᵢ(a), where dᵢ(a) is a true value of the signals, bᵢ(a) is a Gaussian characteristic noise of an i^{th} signal at the moment a, and corresponding variances of the signals are σᵢ².

(2) A weighted average result of information obtained by different data sources is:

s(a)=Σᵢ₌₁ⁱωᵢxᵢ(a)=W^{T}X(a), where W={ω₁, ω₂, . . . , ωᵢ} is an unknown weight matrix, which satisfies Σᵢ₌₁ⁱωᵢ=1;

X={x₁, x₂, . . . , xᵢ} is data collected by using different collection methods at the moment a, and the variance σᵢ² may be denoted as E[Σᵢ₌₁ⁱωᵢ²(x−xᵢ)²]=Σᵢ₌₁ⁱωᵢ²σᵢ².

(3) Obtain a formula

$$( {\sum }_{i = 1}^{i} {ω}_{i}^{2} {σ}_{i}^{2} ) ( {\sum }_{i = 1}^{i} \frac{1}{{σ}_{i}^{2}} ) \geq {( {\sum }_{i = 1}^{i} {ω}_{i} )}^{2} = 1$$

by using Cauchy inequality.

It is inferred, according to the formula, that when and only when ω₁σ₁²=ω₂σ₂²= . . . =ωᵢσᵢ², and Σᵢ₌₁ⁱωᵢ=1 is satisfied to obtain the minimum value, the corresponding total mean square error is also the minimum extremal value.

(4) Calculate fuzzy weights

$${ω}_{i} = \frac{1}{{σ}_{i}^{2} ( \frac{1}{{σ}_{1}^{2}} + … + \frac{1}{{σ}_{i}^{2}} )}$$

and ωᵢ=1−Σᵢ₌₁ⁱ⁻¹ωᵢ of membership by using a method of an extreme value of a multivariate function when the total mean square error is the minimum value.

Step S2 specifically includes: inviting an expert group to establish a fuzzy weight as ωᵢ of artificial intelligence membership based on traffic management experience of the expert group.

In step S3, a fused fuzzy weight

$${ω}_{{1}^{=}} = = \frac{{ω}_{i} + {ω}_{\overline{1}}}{2}$$

is obtained by fusing the first fuzzy weight and the second fuzzy weight, a membership function μ_{\tilde{ω}}_{ᵢ} is used to indicate the fuzzy weight ω_{i̅}, and fuzzy weighted average is performed on different membership functions according to the fuzzy weight to obtain weighted average membership functions

$${μ}_{{\tilde{y}}_{{\tilde{A}}_{i}}} = \frac{{\sum }_{i = 1}^{i} {ω}_{{1}^{=}} {μ}_{{\tilde{A}}_{i}}}{{\sum }_{i = 1}^{i} {ω}_{{1}^{=}}} , {μ}_{{\tilde{y}}_{{\tilde{B}}_{i}}} = \frac{{\sum }_{i = 1}^{i} {ω}_{{1}^{=}} {μ}_{{\tilde{B}}_{i}}}{{\sum }_{i = 1}^{i} {ω}_{{1}^{=}}} , {μ}_{{\tilde{y}}_{{\tilde{C}}_{i}}} = \frac{{\sum }_{i = 1}^{i} {ω}_{{1}^{=}} {μ}_{{\tilde{C}}_{i}}}{{\sum }_{i = 1}^{i} {ω}_{{1}^{=}}} , and {μ}_{{\tilde{y}}_{{\tilde{D}}_{i}}} = \frac{{\sum }_{i = 1}^{i} {ω}_{{1}^{=}} {μ}_{{\tilde{D}}_{i}}}{{\sum }_{i = 1}^{i} {ω}_{{1}^{=}}}$$

having different characteristic quantities.

In step S3, a centroid method is adopted, that is,

$${z}^{*} = \frac{\int μ ( z ) zdz}{\int μ ( z ) dz}$$

to perform defuzzification, and fused multi-source traffic data is obtained, that is, a traffic flow Q, a reaction time T, a speed V, a distance L headway, and vehicle acceleration a.

In step S4, the constructing a road traffic congestion model specifically includes the following.

(1) Select, as input samples, road congestion influence factors such as a traffic flow Q, a reaction time T, a speed V, a distance L headway, and a traffic congestion index Y of adjacent road sections.

(2) Input the input samples having different characteristics into different kernel extreme learning sub-models for training, generate an independent sub-model for each road section, and simultaneously perform a parallel computation to form a road traffic network model capable of predicting the congestion index of a whole road network.

The calculating the optimal road traffic congestion index specifically includes the following.

Five non-repetitive input samples are set to (xᵢ, tᵢ), xᵢ=[xᵢ₁, xᵢ₂, . . . , xᵢₙ]^{T}∈R⁵ is a 5-dimensional input, tᵢ=[tᵢ₁, tᵢ₂, . . . , tᵢₙ]^{T}∈R^{m} is set to be an m-dimensional output corresponding to an input xᵢ, the model has N̆ hidden-layer nodes, and an excitation function g(x) is denoted as Σᵢ₌₁^{N̆}βᵢgᵢ(xᵢ)=Σᵢ₌₁^{N̆}βᵢgᵢ(ωᵢ*xⱼ+bᵢ)=Oⱼ, j=1, . . . , N.

ωᵢ=[ωᵢ₁, ωᵢ₂, . . . , ωᵢₙ]^{T} is set to be an input weight of an i^{th} hidden-layer node, βᵢ=[βᵢ₁, βᵢ₂, . . . , βᵢₙ]^{T} is an output weight of the i^{th} hidden-layer node, bᵢ is an offset of the i^{th} hidden-layer node, and ωᵢ*xⱼ is an inner product of ωᵢ and xⱼ.

If inputs and outputs of a neural network are in perfect fit, that is, when an error is Σᵢ₌₁^{N̆}∥Oⱼ−tⱼ∥=0, βᵢ, ωᵢ and bᵢ exist to cause Σᵢ₌₁^{N̆}βᵢgᵢ(ωᵢ*xⱼ+bᵢ)=tⱼ, j=1, . . . , N to obtain an optimal output. At this point, H is an output matrix of the hidden-layer nodes and is denoted as Hβ=T.

$$H = ( \begin{matrix}{ω}_{1} , … , {ω}_{\check{N}} , & {b}_{1} , … , {b}_{\check{N}} , & {x}_{1} , … , {x}_{\check{N}}\end{matrix} , ) = {[ \begin{matrix}g ( {ω}_{1} * {x}_{1} + {b}_{1} ) & … & g ( {ω}_{\check{N}} * {x}_{N} + {b}_{\check{N}} ) \\ ⋮ & ⋱ & ⋮ \\ g ( {ω}_{1} * {x}_{N} + {b}_{1} ) & … & g ( {ω}_{\check{N}} * {x}_{N} + {b}_{\check{N}} )\end{matrix} ]}_{N \times \check{N}} β = {[ \begin{matrix}{β}_{1}^{T} \\ ⋮ \\ {β}_{\check{N}}^{T}\end{matrix} ]}_{\check{N} \times m} , T = {[ \begin{matrix}{t}_{1}^{T} \\ ⋮ \\ {t}_{N}^{T}\end{matrix} ]}_{N \times m} .$$

According to theory of extreme learning machines, an excitation function is infinitely differentiable, that is, a weight of an input layer and a hidden-layer offset may be randomly assigned, and an input weight co; and the hidden-layer offset bᵢ are fixed to train a feedforward neural network of a single hidden layer.

When one in a linear system Hβ=T satisfies least-square \hat{β}, that is,

$$\hat{β} = {min}_{β} ‖ H \breve{β} - T ‖ ,$$

because in most cases, a number N̆ of hidden-layer nodes and a number N of input non-repetitive training samples are unequal, that is, when N̆<<N,

at this point, β that minimizes a loss function ∥Hβ−T∥ may be calculated, that is,

$$\check{β} = {min}_{β} ‖ H β - T ‖ .$$

According to the minimum norm solution criterion, the least-square solution \hat{β} exists when min∥Hβ−T∥ and min∥β∥ are simultaneously satisfied.

\hat{β}=H⁺T, where H⁺ is an augmented inverse matrix of a hidden-layer matrix H. Assuming an output function h(x) of the hidden-layer nodes is unknown, a kernel function is introduced into the output function to form a kernel extreme learning machine group algorithm.

A random matrix H^{T}H of the extreme learning machine algorithm is replaced by a kernel matrix, and kernel extreme learning machine models of different kernel functions are established. A kernel function is classified according to a kernel function theory, and the kernel function K(μ, ν) includes an RBF kernel function, a linear kernel function, a polynomial kernel function, and the like.

An RBF kernel is usually set to K(μ, ν)=exp[−(μ−ν²/γ)], which is a kernel function, but periodic characteristics of the kernel function are added when sub-models are constructed by characteristic input with obvious periodicity. If a periodic function is

$$K ( μ , v ) = K sin ( \frac{π}{p} r ) ,$$

where p is a period of the kernel function, a form of a periodic kernel obtained from the RBF kernel is

$$K ( μ , v ) = exp [ - \frac{{sin ( \frac{π}{p} r )}^{2}}{γ} ] ,$$

which may be written into the following form: χ_{ELM}_{_{i,j}}=H^{T}H.

χ_{ELM}_{_{i,j}}=h(xᵢ)*h(yⱼ)=K(xᵢ, yⱼ), where K(xᵢ, yⱼ) is a kernel function, and an output formula of KELM may be written into the following form:

$$y = {F}_{E L M} ( x ) = h ( x ) β = [ \begin{matrix}K ( x , {x}_{1} ) \\ ⋮ \\ K ( x , {x}_{n} )\end{matrix} ] {( \frac{1}{C} + {X}_{ELM} )}^{- 1} Y ,$$

where C is a penalty factor constant, the generalization ability of a learning machine is adjusted and optimized by using the penalty factor C and a kernel parameter γ in the formula, and the optimal road traffic congestion index Y′ is obtained.

In this embodiment, the greatest strength of the model is that unknown quantities such as a number of hidden-layer nodes, initial weight values, and offsets do not need to be considered during solving, and the value of a prediction function may be calculated by directly using the inner product form of an inner kernel function and the specific form of the kernel function K(μ, ν), so that the optimal road traffic congestion index Y′ can be conveniently and rapidly obtained.

In this embodiment, the traffic management experience of people is combined with the rapid and precise operational capability of machines through a minimum weighted average algorithm and fuzzy determination inference, so as to calculate precise road traffic fusion data. A road characteristic is extracted by using the data, and the optimal road traffic congestion index Y′ is predicted by applying a kernel extreme learning machine group algorithm, which gives full play to the advantages of man-machine hybrid augmented intelligence. The rapid and precise prediction for road congestion indexes provides powerful data support for the man-machine hybrid augmented intelligence platform for warning congestion.

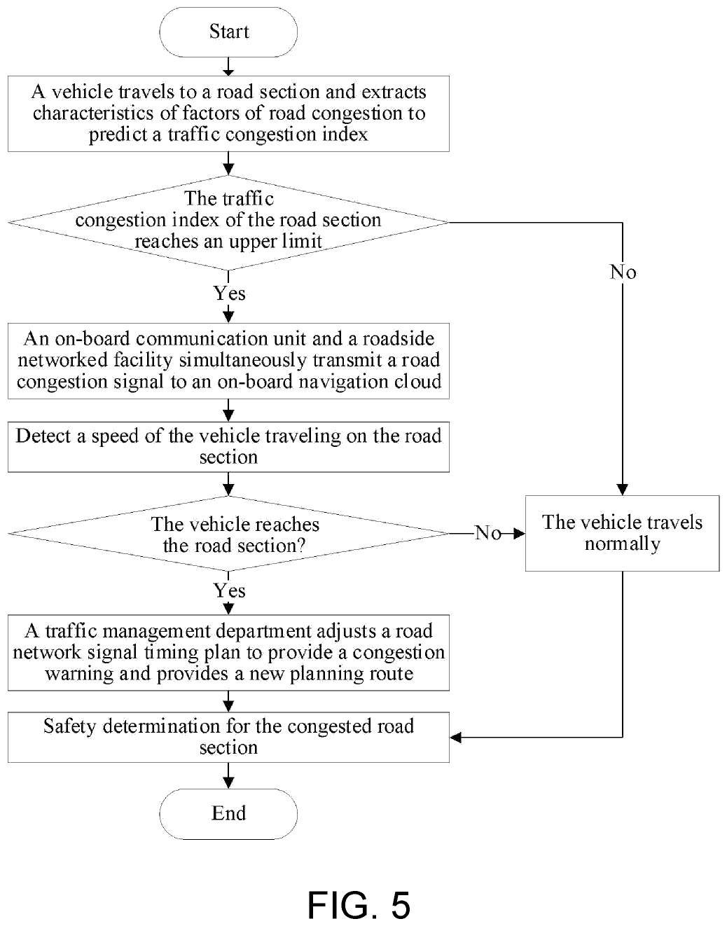

In step S5, as shown in FIG. 5, a process for warning and determining road congestion is as follows.

When a vehicle travels to a road section, multi-source traffic data of the current road section is acquired.

Characteristic extraction is performed on influence factors of road congestion, and a current congestion index is predicted according to a road traffic congestion model.

The current congestion index is compared with the optimal road traffic congestion index, and when traffic flow on the road section reaches an upper limit of the predicted congestion index, a road congestion warning signal is transmitted, or otherwise, the vehicle travels normally.

In this embodiment, the road congestion warning signal may be transmitted to an on-board navigation cloud simultaneously by an on-board communication unit and a road side networked facility, and the traveling speed of the vehicle traveling on the road section is detected. A road network signal timing plan is adjusted to give a congestion warning if the vehicle arrives at the road section, and a new planning route is provided.

In addition, it may be understood that traffic management departments may let drivers participate in the field test of the congested road section in the manner of real-name authentication through mobile phone apps. When congestion sense organs of most drivers on the congested road section conflict with congestion indexes, the greatest control power of human is guaranteed by using the feelings of most drivers as the standard, and the cloud cleans the road congestion signal.

Furthermore, it may be understood that after the cloud receives a signal indicating congestion, drivers can obtain traffic information of the front road section with the help of on-board navigation and mobile phone apps, and the warning system can determine the congestion status according to the condition of road congestion. In addition, a real-time speed of a vehicle is tested, it is pre-determined that how long the vehicle will travel to the congested road section, and several reasonable routes for avoiding congestion are given. Moreover, a large LED screen at the intersection in front of the congested road section displays information such as the congestion conditions and traffic flow of the road section, thereby providing timely congestion warning for the vehicle ready to travel to the congested road section.

By analyzing real-time status of congestion conditions of each road in a city, a traffic management center introduces experiential wisdom of traffic managers and professional analysis of experts, and establishes new signal optimization models to deliver optimal signal optimization schemes calculated in real time to each intersection, to reasonably regulate signal light phases at each intersection, so as to form a green wave band as much as possible and establish a signal timing optimization network for regional linkage. In addition, each intersection has a specific capability of self-optimization and regulation. When congestion traffic flow on arterial roads and sub-arterial roads intersects, green wave passing of the arterial roads is preferably considered to avoid occurrence of more congestion conditions, thereby forming a distributed intelligence control platform having an adaptive capability. In this embodiment, the traffic signal phases at each intersection and roadside warning facilities are regulated and controlled through the network brain, thereby achieving coordination of machine intelligence and human intelligence, so as to jointly resolve the problem of urban congestion in congestion warning by integrating machine intelligence and swarm intelligence into urban roads.

### Embodiment 2

This embodiment provides a road traffic jam early warning system, including:

a first fuzzy weight calculation module, configured to perform characteristic classification according to acquired multi-source traffic data, construct a corresponding characteristic membership function, and apply a minimum weighted average algorithm to the characteristic membership function to obtain a first fuzzy weight;

a second fuzzy weight calculation module is configured to apply an expert evaluation method to the multi-source data to construct an artificial membership function, and calculate a second fuzzy weight;

a fusion module is configured to perform fuzzy weighted average on the characteristic membership function according to a fused fuzzy weight obtained by fusing the first fuzzy weight and the second fuzzy weight, and perform defuzzification on obtained weighted average membership functions having different characteristic quantities, to obtain fused multi-source traffic data;

a model construction module is configured to apply a kernel extreme learning machine group algorithm to the fused multi-source traffic data to construct a road traffic congestion model, and calculate an optimal road traffic congestion index; and

a congestion warning module is configured to acquire current multi-source traffic data, predict a current congestion index according to the road traffic congestion model, and provide a warning about whether a current road is congested by comparing the current congestion index with the optimal road traffic congestion index.

It should be noted herein that the above modules correspond to steps S1-S5 in Embodiment 1, examples and application scenarios implemented by the above modules and the corresponding steps are the same, which are not limited to the contents disclosed in Embodiment 1. It is to be noted that, as a part of a system, the above modules can be executed in a computer system executing a set of computer executable instructions.

### Embodiment 3

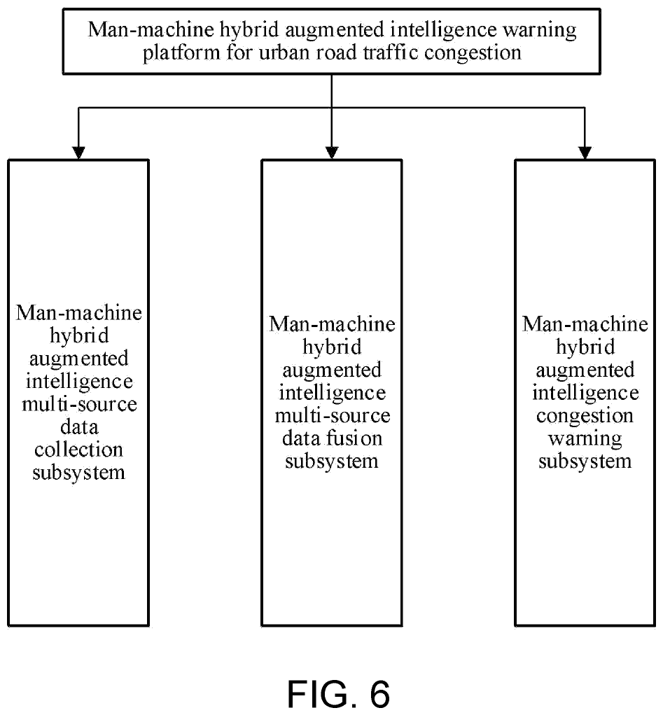

As shown in FIG. 6, an embodiment provides a warning platform, including a man-machine hybrid augmented intelligence multi-source data collection subsystem, a man-machine hybrid augmented intelligence multi-source data fusion subsystem, and a man-machine hybrid augmented intelligence congestion warning subsystem.

The man-machine hybrid augmented intelligence multi-source data collection subsystem is composed of various sensing devices and traffic participants.

Various sensing devices includes fixed sensing devices laid on a road network and movable sensing devices mounted on vehicles, which are respectively configured to collect road traffic data such as traffic flow, a number of lanes, a speed, road weather, and traffic accident conditions, and collect vehicle traffic data and behavior characteristic data of drivers such as positions of vehicles, vehicle acceleration, distances headway, and operation behaviors of the drivers, and the like.

The data collected from the traffic participants mainly includes human perception, management experience, and policy activity information. Firstly, basic road information such as a movement track, a time period of crossing an intersection, accident-prone sections, road infrastructure status of the pedestrians is provided by using the pedestrians on the urban road. Secondly, perceptual information of the driver such as road familiarity and driving skills of the driver, mental status, driving habits, reaction time, and the like is provided by means of a driver of a traveling vehicle. Thirdly, control policy experience information such as traffic congestion status determination rules, road traffic management experience, real-time traffic information of road sections, congestion processing policies, urban traffic control schemes, situations of surrounding large-scale activities, and the like is provided by a traffic manager.

The man-machine hybrid augmented multi-source data collection subsystem establishes a man-machine hybrid platform for collecting urban road traffic information by using sensing devices mounted on the urban roads and vehicles and traffic participants. The subsystem converts traffic data provided by the traffic participants into App points through mobile phone APPs, and the points can be used for exchanging small gifts such as gas filling cards or high-speed passing coupons, so as to motivate the traffic participants to provide perception information for us. Through the interconnection among vehicles traveling on roads, traffic participants, and road infrastructures, a local data collection platform of vehicle-to-vehicle, vehicle-to-road, vehicle-to-person, and vehicle-to-infrastructure is formed, which greatly enhances environment perception of different data collection sources to obtain more accurate road traffic data.

The man-machine hybrid augmented intelligence multi-source data fusion subsystem simply classifies the traffic data collected from the data collection subsystem, and transmits the classified data to data processing departments corresponding to a smart city big-data center, thereby performing data pre-processing on multi-source heterogeneous data.

It may be understood that, the process, implemented by the man-machine hybrid augmented intelligence multi-source data fusion subsystem, of constructing a membership function for multi-source traffic data, the fusion of fuzzy weights, and the construction of a road traffic congestion model corresponds to the method in Embodiment 1, and details are not described herein again.

At the warming stage of road congestion, congestion determination is performed by using the congestion indexes calculated by the multi-source data fusion subsystem, and when road traffic indexes at a monitoring road section are larger than the congestion indexes, traffic guidance may be conducted for drivers or pedestrians by adjusting signal timing plans of each road section of the city, so as to resolve congestion problems of urban roads.

The man-machine hybrid augmented intelligence congestion warning subsystem is composed of road warning facilities and vehicle warning devices. When a vehicle travels to a road section, a multi-source signal data fusion module provides traffic parameters of the road section, and extracts characteristics of influence factors of road congestion. When a traffic flow at the road section reaches an upper limit of a predicted congestion index, an on-board communication unit and a roadside networked facility simultaneously transmit a road congestion signal to the on-board navigation cloud.

In addition, traffic management departments may let drivers participate in the field test of the congested road section in the manner of real-name authentication through mobile phone apps. When congestion sense organs of most drivers on the congested road section conflict with congestion indexes, the greatest control power of human is guaranteed by using the feelings of most drivers as the standard, and the cloud cleans the road congestion signal.

After the cloud receives a signal indicating congestion, drivers can obtain traffic information of the front road section with the help of on-board navigation and mobile phone apps, and the warning system can determine the congestion status according to the condition of road congestion. In addition, a real-time speed of a vehicle is tested, it is pre-determined that how long the vehicle will travel to the congested road section, and several reasonable routes for avoiding congestion are given. Moreover, a large LED screen at the intersection in front of the congested road section displays information such as the congestion conditions and traffic flow of the road section, thereby providing timely congestion warning for the vehicle ready to travel to the congested road section.

By analyzing real-time status of congestion conditions of each road in a city, a traffic management center introduces experiential wisdom of traffic managers and professional analysis of experts, and establishes new signal optimization models to deliver optimal signal optimization schemes calculated in real time to each intersection, to reasonably regulate signal light phases at each intersection, so as to form a green wave band as much as possible and establish a signal timing optimization network for regional linkage. In addition, each intersection has a specific capability of self-optimization and regulation. When congestion traffic flow on arterial roads and sub-arterial roads intersects, green wave passing of the arterial roads is preferably considered to avoid occurrence of more congestion conditions, thereby forming a distributed intelligence control platform having an adaptive capability.

In this embodiment, the platform regulates traffic signal phases at each intersection and roadside warning facilities through the network brain, thereby achieving coordination of machine intelligence and human intelligence, so as to jointly resolve the problem of urban congestion in congestion warning by integrating machine intelligence and swarm intelligence into urban roads.

The platform gives full play to accurate hyperoperation capability of machines processing mass data and the determination capability of road traffic participants and managers for road congestion through the mutual cooperation of the swarm intelligence of human being and machine intelligence, so that a human-based man-machine hybrid augmented intelligence system for road warning through combination of human and machines can be formed.

In more embodiments, an electronic device is further provided, including:

An electronic device, comprising a memory, a processor and computer instructions stored on the memory and executed on the processor, wherein the method of the Embodiment 1 is completed when the computer instructions are executed by the processor. For brevity, details are not described herein again.

It should be understood that in this embodiment, the processor may be a central processing unit (CPU); or the processor may be another general purpose processor, a digital signal processor (DSP), an application-specific integrated circuit (ASIC), a field programmable gate array (FPGA) or another programmable logical device, a discrete gate or a transistor logical device, a discrete hardware component, or the like. The general-purpose processor may be a microprocessor, or the processor may be any conventional processor and the like.

The memory may include a read-only memory and a random-access memory, and provide an instruction and data to the processor. A part of the memory may further include a non-volatile random-access memory. For example, the memory may further store information about a device type.

Further provided is a computer readable storage medium, configured to store the computer instructions, wherein the method of the Embodiment 1 is completed when the computer instructions are executed by the processor.

The method in Embodiment 1 may be directly performed and completed by a hardware processor, or may be performed and completed by using a combination of hardware in the processor and a software module. The software module may be located in a mature storage medium in the field such as a random access memory, a flash memory, a read-only memory, a programmable read-only memory, an electrically erasable programmable memory, or a register. The storage medium is located in the memory. The processor reads information in the memory and completes the steps of the foregoing methods in combination with hardware thereof. To avoid repetition, details are not described herein again.

A person of ordinary skill in the art may notice that the exemplary units and algorithm steps described with reference to this embodiment can be implemented in electronic hardware, or a combination of computer software and electronic hardware. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of this application.

The foregoing descriptions are merely preferable embodiments of the present disclosure, but are not intended to limit the present disclosure. The present disclosure may include various modifications and changes for a person skilled in the art. Any modification, equivalent replacement, or improvement and the like made within the spirit and principle of the present disclosure shall fall within the protection scope of the present disclosure.

The specific implementations of the present disclosure are described above with reference to the accompanying drawings, but are not intended to limit the protection scope of the present disclosure. A person skilled in the art should understand that various modifications or deformations may be made without creative efforts based on the technical solutions of the present disclosure, and such modifications or deformations shall fall within the protection scope of the present disclosure.

1. A road traffic jam early warning method, comprising:
performing characteristic classification according to acquired multi-source traffic data, constructing a corresponding characteristic membership function, and applying a minimum weighted average algorithm to the characteristic membership function to obtain a first fuzzy weight;
applying an expert evaluation method to the multi-source traffic data to construct an artificial membership function, and calculating a second fuzzy weight;
performing fuzzy weighted average on the characteristic membership function according to a fused fuzzy weight obtained by fusing the first fuzzy weight and the second fuzzy weight, and performing defuzzification on obtained weighted average membership functions having different characteristic quantities, to obtain fused multi-source traffic data;
applying a kernel extreme learning machine group algorithm to the fused multi-source traffic data to construct a road traffic congestion model, and calculating an optimal road traffic congestion index; and
acquiring current multi-source traffic data, predicting a current congestion index according to the road traffic congestion model, and providing, by comparing the current congestion index with the optimal road traffic congestion index, a warning about whether a current road is congested.

2. The road traffic jam early warning method according to claim 1, wherein
obtaining a road characteristic, a human characteristic, an environment characteristic, and a vehicle characteristic after the characteristic classification performed on the multi-source traffic data, the road characteristic comprises a traffic flow, a number of lanes, and a road grade, the human characteristic comprises a behavior characteristic of a driver and a behavior characteristic of a pedestrian, the environment characteristic comprises information such as road weather and a traffic accident, and the vehicle characteristic comprises a position, a speed, a distance headway, and a vehicle condition.

3. The road traffic jam early warning method according to claim 1, wherein
constructing characteristic domains according to a characteristic classification result, grading characteristic data in each of the characteristic domains to construct a corresponding fuzzy inference rule table, establishing a fuzzy subset corresponding to a fuzzy inference grade domain according to the fuzzy inference rule table, and obtaining the characteristic membership function by means of fuzzy mapping.

4. The road traffic jam early warning method according to claim 3, wherein
performing weighted average on data of the different characteristic domains, applying a Cauchy inequality to obtain a minimum value of a total mean square error, and calculating a first fuzzy weight by using an extreme value of a multivariate function when the total mean square error is the minimum value.

5. The road traffic jam early warning method according to claim 1, wherein
the defuzzification uses a centroid method to obtain the fused multi-source traffic data comprised a traffic flow, a reaction time, a speed, a distance headway, and a vehicle acceleration.

6. The road traffic jam early warning method according to claim 1, wherein
acquiring the fused multi-source traffic data as an input sample to train a kernel extreme learning sub-model, so as to obtain sub-models having different characteristic quantities; and
performing a parallel computation on the sub-models having the different characteristic quantities, and constructing a road traffic congestion model.

7. The road traffic jam early warning method according to claim 1, wherein
calculating the optimal road traffic congestion index according to an inner product form and a kernel function of an inner kernel function of the kernel extreme learning machine group algorithm.

8. A road traffic jam early warning system, comprising:
a first fuzzy weight calculation module configured to perform characteristic classification according to acquired multi-source traffic data, construct a corresponding characteristic membership function, and apply a minimum weighted average algorithm to the characteristic membership function to obtain a first fuzzy weight;
a second fuzzy weight calculation module configured to apply an expert evaluation method to the multi-source data to construct an artificial membership function, and calculate a second fuzzy weight;
a fusion module configured to perform fuzzy weighted average on the characteristic membership function according to a fused fuzzy weight obtained by fusing the first fuzzy weight and the second fuzzy weight, and perform defuzzification on obtained weighted average membership functions having different characteristic quantities, to obtain fused multi-source traffic data;
a model construction module configured to apply a kernel extreme learning machine group algorithm to the fused multi-source traffic data to construct a road traffic congestion model, and calculate an optimal road traffic congestion index; and
a congestion warning module configured to acquire current multi-source traffic data, predict a current congestion index according to the road traffic congestion model, and provide, by comparing the current congestion index with the optimal road traffic congestion index, a warning about whether a current road is congested.

9. An electronic device, comprising a memory, a processor, and computer instructions stored in the memory and executable on the processor, wherein when the computer instructions are executed by the processor, the method according to claim 1 is performed.

10. A computer readable storage medium, configured to store computer instructions, wherein when the computer instructions are executed by a processor, the method according to claim 1 is performed.
